(19) United States
(12) Patent Application Publication
(10) Pub. No.: US 2002/0013740 A1
(43) Pub. Date: Jan. 31, 2002

(54) Communication method, network apparatus or system for buying new item or picking up item

(76) Inventors: Kiyotaka Kodama, Kanagawa (JP); Makoto Hasegawa, Kanagawa (JP)

Correspondence Address: ROBIN BLECKER & DALEY, 2ND FLOOR, 330 MADISON AVENUE, NEW YORK, NY, 10017, US

(21) Appl. No.: 09/899,655

(22) Filed: Jul. 5, 2001

(30) Foreign Application Priority Data
Jul. 11, 2000 (JP) 210144/2000

(51) Int. Cl. G06F 17/60

(52) U.S. Cl. 705/26

(57) ABSTRACT

With the change of the times, it is guessed that, in the near future, of not only home electric equipments but also office automation equipments such as printers for recycling would be under an obligation to be collected for recycling. Since the collection of such home electric equipments or the office automation equipments is a burden to the user or the collector, an efficiently collecting method has been desired or required.

In order to solve the above problem, it is provided that a communication method suitable for effecting purchasing of a new item or picking-up of an item to be recycled, comprising the steps of designating request for purchasing a new item or picking up an item, designating a place where said purchasing or picking-up is performed, and notifying the designated request and the designated place to an external place through a network.

### BACKGROUND OF THE INVENTION

1. Field of the Invention

The present invention relates to a network communication technology, and more particularly, it relates to a network communication technology suitable for buying a new item or picking up an item.

2. Related Background Art

An item which has been needless by purchasing a new item has often been discarded as a junk.

With the change of the times, it is guessed that, in the near future, of not only home electric equipments but also office automation equipments such as printers for recycling would be under an obligation to be collected for recycling. Since the collection of such home electric equipments or the office automation equipments is a burden to a user or a junk dealer, an efficiently collecting method has been desired or requested.

Further, when the item is collected efficiently, the recycling will be hot up and the item manufactures can use the recycled items, and thereby preventing deterioration of environment and permitting effective use of resources.

### SUMMARY OF THE INVENTION

An object of the present invention is to provide a network apparatus, a network system, a communication method and a recording medium, by which purchasing of a new item and picking-up of an item to be recycled can be effected efficiently.

According to an aspect of the present invention, there is provided a network apparatus comprising request designating means for designating request for purchasing a new item or picking up an item to be recycled, place designating means for designating a place where said purchasing or picking-up is performed, and communication means for notifying the request information designated by the request designating means and the place designated by the place designating means to an external place through a network.

According to another aspect of the present invention, there is provided a network apparatus comprising input means for inputting request information regrading request for purchasing of a new item or picking up an item to be recycled and place information regarding a place where said purchasing or picking-up is performed through a network, and output means for outputting a purchasing date or a pick-up date through the network to inform a user (requester) of the purchasing date or the pick-up date.

According to a further aspect of the present invention, there is provided a network apparatus comprising input means for inputting request information regarding request for purchasing of a new item or picking up an item to be recycled and place information regarding a place where said purchasing or picking-up is performed through a network, output means for outputting a purchasing date or a pick-up date for the item through the network to inform a user of the purchasing date or the pick-up date, and completion information acquiring means for acquiring information regarding completion of the pick-up through the network.

According to a still further aspect of the present invention, there is provided a network system in which a first network apparatus and a second network apparatus are interconnected through a network, wherein the first network apparatus comprises request designating means for designating request for purchasing a new item or picking up a item to be recycled, place designating means for designating a place where said purchasing or picking-up is performed, and communication means for notifying the request information designated by the request designating means and the place designated by the place designating means to the second network apparatus through the network, and the second network apparatus comprises input means for inputting request information regarding the request for purchasing of a new item or picking up an item to be recycled and place information regarding the place where said purchasing or picking-up is performed from the first network apparatus through the network, and output means for outputting a purchasing date or a pick-up date to the first network apparatus through the network to inform a user of the purchasing date or the pick-up date.

According to a further aspect of the present invention, there is provided a network system in which a first network apparatus and a second network apparatus are interconnected through a network, wherein the first network apparatus comprises input means for inputting request information regarding request for purchasing of a new item or picking up an item to be picked up and place information regarding a place where said purchasing or picking-up is performed through the network, output means for outputting a purchasing date or a pick-up date through the network to inform a user of the purchasing date or the pick-up date, and completion information acquiring means for acquiring information regarding completion of said pick-up from the second network apparatus through the network, and the second network apparatus comprises notifying means for informing the first network apparatus of the information regarding the completion of said pick-up, after the completion.

According to a still further aspect of the present invention, there is provided a network system in which first to third network apparatuses are interconnected through a network, wherein the first network apparatus comprises request designating means for designating request for purchasing a new item or picking up an item to be recycled, place designating means for designating a place where said purchasing or picking-up is performed, and communication means for notifying the request information designated by the request designating means and the place designated by the place designating means to the second network apparatus through the network, the second network apparatus comprises input means for inputting request information regarding the request for purchasing a new item or picking up an item to be recycled and place information regarding a place where said purchasing or picking-up of the item is performed from the first network apparatus through the network, output means for outputting a purchasing date or a pick-up date to the first network apparatus through the network to inform a user of the purchasing date or the pick-up date, and completion of said pick-up from the third network apparatus through the network, and the third network apparatus comprises notifying means for informing the second network apparatus of the information regarding the completion of said pick-up, after the completion.

According to a further aspect of the present invention, there is provided a communication method comprising the steps of (a) designating request for purchasing a new item or picking up an item to be recycled, (b) designating a place where said purchasing or picking-up of the item is performed, and (c) notifying the designated request and the designated place to an external place through a network.

According to a still further aspect of the present invention, there is provided a communication method comprising the steps of (a) inputting request information regarding request for purchasing of a new item or picking up an item to be recycled and place information regarding a place where said purchasing or picking-up of the item is performed through a network, and (b) outputting a purchasing date or a pick-up date through the network to inform a user of the purchasing date or the pick-up date.

According to a further aspect of the present invention, there is provided a computer-readable recording medium for storing a program having a sequence which is executed by a computer, wherein the sequence comprises the steps of (a) designating request for purchasing a new item or picking up an item to be recycled, (b) designating a place where said purchasing or picking-up is performed, and (c) notifying the designated request and the designated place to an external place through a network.

According to a still further aspect of the present invention, there is provided a computer-readable recording medium for storing a program having a sequence which is executed by a computer, wherein the sequence comprises the steps of (a) inputting request information regarding request for purchasing of a new item or picking up an item to be recycled and place information regarding a place where said purchasing or picking-up is performed through a network, and (b) outputting a purchasing date or a pick-up date through the network to inform a requester of the purchasing date or the pick-up.

The other objects and features of the present invention will be apparent from the following detailed explanation of the invention referring to the accompanying drawings.

### BRIEF DESCRIPTION OF THE DRAWINGS

FIG. 1 is a block diagram showing constituents of a network system according to an embodiment of the present invention;

FIG. 2 is a block diagram showing constituents of a computer;

FIG. 3 is a flow chart showing processing executed by the network system;

FIG. 4 is a view showing a user request view; and

FIG. 5 is a view showing contents of data base.

### DETAILED DESCRIPTION OF THE PREFERRED EMBODIMENTS

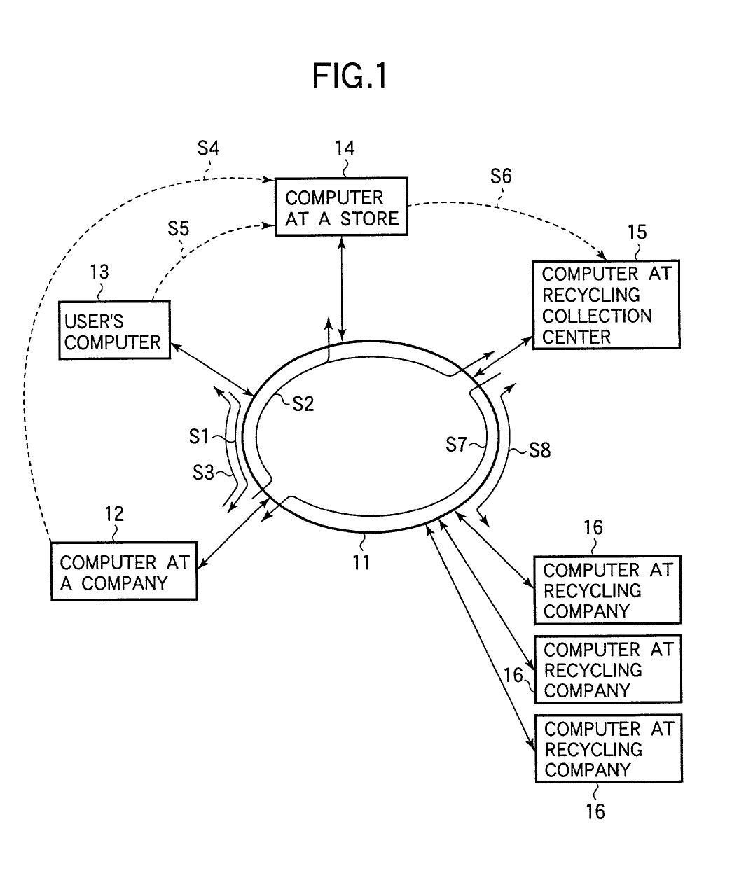

FIG. 1 is a block diagram showing constituents of a network system according to an embodiment of the present invention. To a network 11 such as an internet, there are connected a computer 12 at a company, a user's computer 13, a computer 14 at a convenience store, a computer 15 at a recycling collection center, and a plurality of computers 16 at recycling companies. Incidentally, although installation of the computer 14 at the convenience store is shown, such installation is not limited to the convenience store, but it can be installed at supermarkets, drug stores or the like, so long as any item can be handed over. Accordingly, hereinafter, such convenience store and the like is generically referred to as “store”.

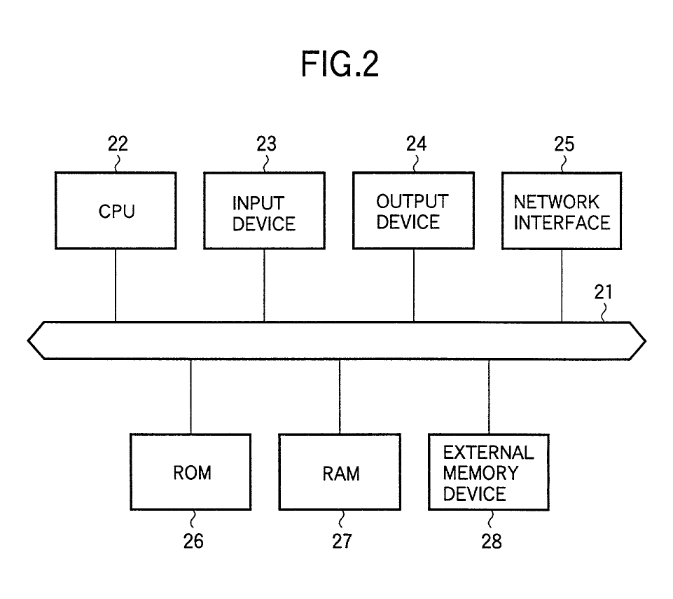

FIG. 2 shows constituents of each of the computers 12 to 16. For example, the computers 12 to 16 are general purpose computers such as personal computers having the same construction. A central processing unit (CPU) 22, an input device 23, an output device 24, a network interface 25, a ROM 26, a RAM 27 and an external storing device 28 are connected to a bus 21.

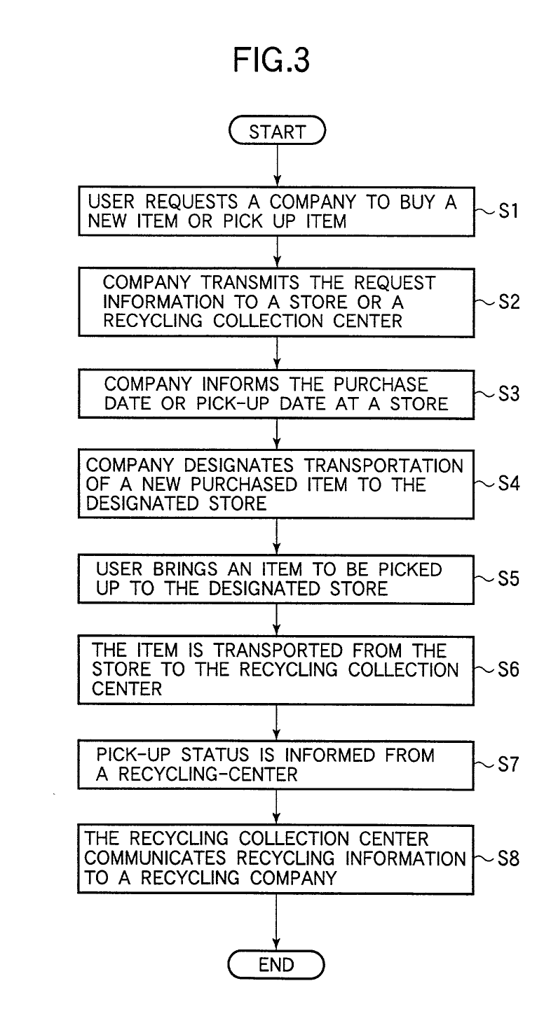

The CPU 22 serves to perform processing and calculation of data and to control various constructural elements connected thereto via the bus 21 and executes processing shown in a flow chart of FIG. 3 which will be described later.

A control procedure (computer program) of the CPU 22 is previously stored in the ROM 26, and, by executing the computer program by means of the CPU 22, processing such as input/output of data and communication of data can be performed. The RAM 27 serves as a work area for the input/output of data and communication of data and as temporal memory for control of various constructural elements.

The external storing device 28 may be, for example, a hard disk storing device or a CD-ROM in which stored contents are not erased even if the power supply is turned OFF. The network interface 25 is an interface through which the computers 12 to 16 and the network 11 shown in FIG. 1 are interconnected. The input device 23 may comprise, for example, a keyboard and a mouse and serves to perform various designation and input. The output device 24 may comprise, for example, a display and a printer and serves to display a picture plane and effect printing.

Means for supplying the computer program to the computer, for example, a recording medium storing such computer program constitutes the present invention. Such a recording medium storing the computer program may be, for example, a floppy disk, a hard disk, an optical disk, a photo-magnetic disk, a CD-ROM, a magnetic tape, a non-volatile memory card or a ROM. The computer program in the recording medium is copied on the RAM 27 and is executed.

FIG. 3 is a flow chart showing the processing executed by the network system according to the illustrated embodiment. Now, such processing will be explained with reference to FIGS. 1 and 3. In FIG. 1, the solid arrows show flow of information (data) on on-line through the network, and the broken line arrows show flow of an item on-line and correspond to steps S1 to S8 in FIG. 3.

In a step S1, the user request a company to buy or purchase a new item or to pick up an item. More specifically, the user's computer 13 accesses to a home page of the computer 12 at the company through the network 11.

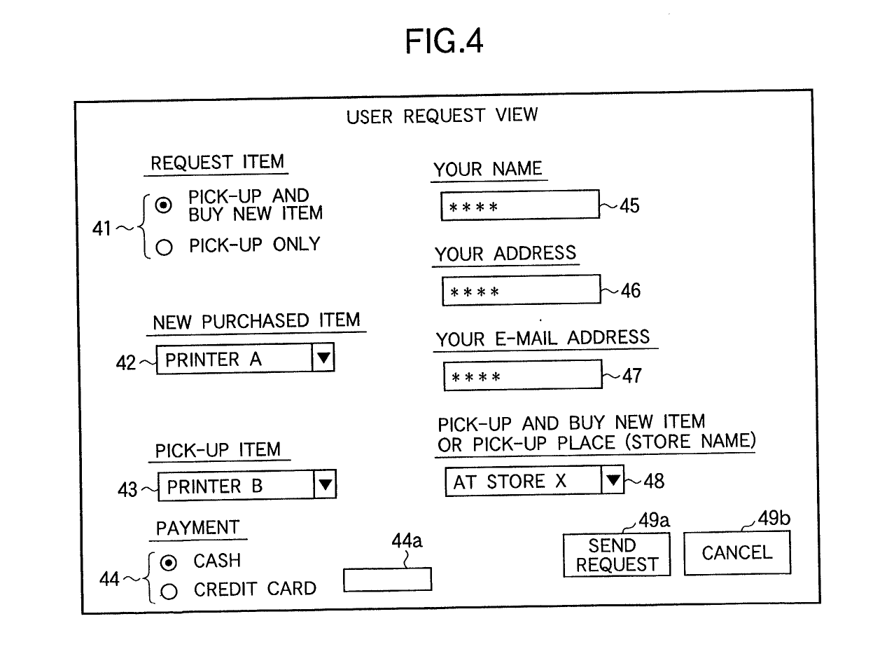

As a result, a user request view shown in FIG. 4 is displayed on the user's computer 13. Then, the user inputs the following items. As a request item 41, the user can select either “pick-up and buy new item” or “pick-up only”. Here, “pick-up and buy new item” means that a new item is purchased and an item which was not required is picked up for recycling; whereas, “pick-up only” means that an item which was not required is merely picked up for recycling. The item may be, for example, an office automation (OA) equipment or a home electric equipment.

When the “pick-up and buy new item” is selected, a name of an item 42 to be newly purchased and a name of an item 43 to be picked up are inputted. On the other hand, when the “pick-up only” is selected, the name of the item 43 to be picked up is inputted. The item 42 to be newly purchased can be selected among OA equipment or home electric equipments displayed in a menu item and, for example, as the name of the item, a printer A can be selected. Similarly, as the name of the item 43 to be picked up, a printer B can be selected.

As a payment method 44, “cash” or “credit card” can be selected. In case of the picking-up of the item, it is necessary for the user that a pick-up charge (recycling charge) be paid to be picked up the item. In case of the purchasing of new item and the picking-up of the old item, in place of the pick-up charge, a charge for the newly purchased item must be paid. If the “credit card” is selected as the payment method 44, a credit number is inputted into an input area 44a.

A name of the requester (user) designating the request is inputted into a your name area 45. The address of the user is inputted into a your address area 46. An E-mail address of the user is inputted into a your E-mail address area 47.

A name of a desired store is selected among the stores displayed in the menu item and the selected store name is inputted into a pick-up and buy new item or pick-up place area 48. The user brings the item to be picked up to the selected store so that can perform the purchasing of new item and the picking-up of the old item or the picking-up of the item at that store. In this case, since the user's address was already inputted in the your address area 46, when one or plural stores in the vicinity of the user's address are displayed as a menu item, the user can easily select the nearest store among the displayed stored. When the stores in the vicinity of the requester's address are displayed, the stores may be displayed as map information so that the requester can select the desired store on the map by using the mouse.

Lastly, when a request button 49a is clicked by the mouse, the request information is sent from the user's computer 13 to the computer 12 at the company. If a cancel button 49b is clicked by the mouse, the sending is not effected and the user request view is ended.

In a step S2 of FIG. 3, the computer 12 at the company sends the received request information to the computer 14 at the store and the computer 15 at the recycling collection center. In this case, in addition to the request information, identification information required for purchasing the new item and picking up the old item or picking up the item is also sent to the computer 14 at the store. The identification information is verified between the user and the store to ascertain whether the user is a requester, when the purchasing of new item and the picking-up of the old item or the picking-up of the item at that store.

In a step S3, the computer 12 at the company ascertains storage of the item to be newly purchased and sends to the user's computer 13 information regarding a purchase date or a pick-up date, as well as the identification information. Such sending is effected via E-main to an E-mail address shown in FIG. 4. The user can perform the purchasing of the new item and picking-up of the old item or the picking-up the item at the store on the designated date or thereafter.

In a step S4, when purchasing of a new item and picking-up of the old item are designated by a user, the company commands a transportation company to send the item to be newly purchased to the designated store. The transportation company forwards the item to be newly purchased to the store designated by the company up to the purchase date.

In a step S5, the user brings the item to be picked up to the store 48 designated in FIG. 4 on or after the designated date, thereby performing the purchasing of new item and the picking-up of the old item or the picking-up of the item. In this case, a user brings a request card on which the identification information was printed by the printer of the user's computer 13 to the store. The store ascertains whether the user is a requester or not by collating the identification information written on the request card with the identification information received in the step S2 (personal verification). However, if the printer was broken or if the user does not have the printer, the user may tell the identification information to the store orally for the personal verification.

After the personal verification, the purchasing of the new item and picking-up of the old item or the the item to be picked up is performed. Regarding the the item to be picked up, the user hands over the item to be picked up to the store. When the user selects the cash payment, he pays the pick-up charge to the store. Regarding the purchasing of the new item and picking-up of the old item, the user hands over the item to be picked up to the store and receives the new item. When the user selects the cash payment, he pays the pick-up charge and the item charge to the store.

In a step S6, the store sticks a recycling card or a forwarding ticket on the picked-up item and requests the transportation company to handle the picked-up item. The transportation company forwards the picked-up item from the store to the recycling collection center (computer 15). The recycling card may be issued from the store or may be issued from the company and sent to the store. Incidentally, although it is considered that the user pays the pick-up charge and purchases the recycling card at a post office, in such a case, since the user must take the trouble to go to post office for buying the recycling card, the user will come less frequently. Thus, as mentioned above, by attempting that the store issues the recycling card and sticks it to the picked-up item, the user's trouble can be reduced and the recycling can be promoted. Further, the forwarding ticket can be printed by the printer on the basis of the request information and the forwarding place received by the computer 14 at the store.

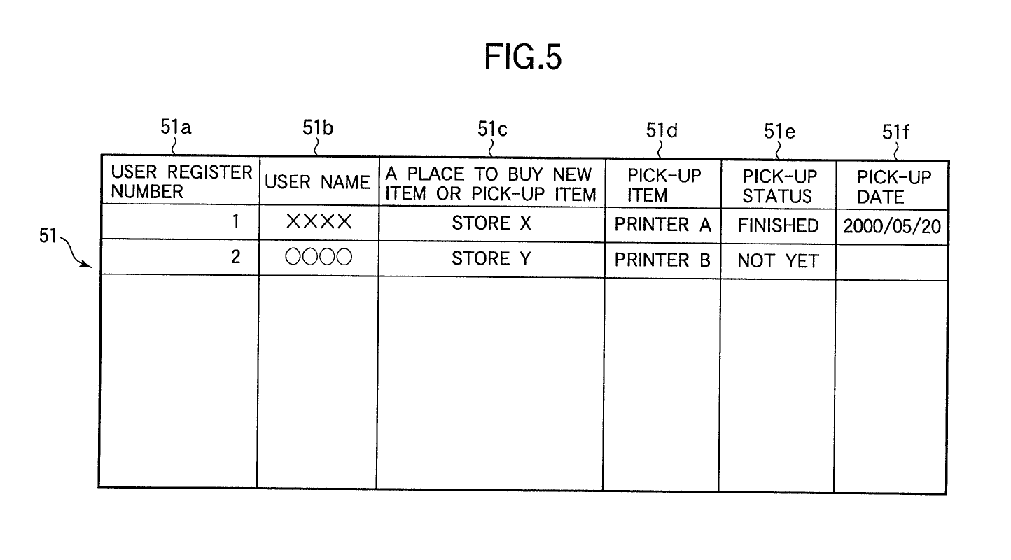

In a step S7, the pick-up status is informed from the computer 15 at the recycling collection center to the computer 12 at the company. More specifically, in the computer 15 at the recycling collection center, a database 51 shown in FIG. 5 is formed on the basis of the request information received in the step S2. The database 51 includes a user (requester) registration number 51a, a user name 51b, a place 51c to buy new item or pick up item, a pick-up item 51d, a pick-up status 51e and a pick-up date 51f.

The user registration number 51a is a number assigned to a new user. Once the number is registered, only by inputting the user registration number 51a via the user request view shown in FIG. 4, the request can be effected without inputting the address 46, E-mail address 47 and pick-up and buy new item or pick-up place 48. The user registration number 51a are also included in the computer 12 at the company and the computer 14 at the store, as well as the computer 15 at the recycling collection center.

The items 51b to 51d in the database are the same as the above-mentioned request information. The pick-up status 51e represents “finished” when the item to be picked up reaches the recycling collection center or “not yet” when the item does not yet reach the center. The pick-up date is inputted to the pick-up date item 51f.

The database 51 may be sent from the computer 15 at the recycling collection center to the computer 12 at the company, or the computer 12 at the company may directly inspect the database 51 in the computer 15 at the recycling collection center. The computer 12 at the company can judge whether the purchasing of the new item and picking-up of the old item or the picking-up the item is finished or not on the basis of the database 51. In the case where it is judged that the purchasing of the new item and picking-up of the old item or the picking-up the item is finished, when the user selects the payment by the credit card, the credit card payment processing is effected.

In a step S8, communication of recycling information is effected between the computer 15 at the recycling collection center and the computer 16 at the recycling company. That is to say, in the recycling collection center, the picked-up item is decomposed into various parts, and respective parts are received by different recycling companies 16. The parts are used in new items.

As mentioned above, the request for purchasing the new item or picking up the item can be effected by inputting required items on the home page via the network. The user can easily effects the purchasing of the new item or picking up of the item at the nearest store. The store sticks the recycling card to the picked-up item and forwards it to the recycling collection center. After the picked-up item is received, the recycling collection center informs the company of the fact that the pick-up is finished. On the basis of such information, the company can judge that the purchasing of the new item or picking up of the item is finished. The purchasing of the new item or picking up of the item can be effected without bring trouble to a user by using the on-line network efficiently. Further, since the user's burden is reduced, the recycling can be promoted and the resources can be utilized effectively in the viewpoint of environment.

Further, since the user go to store for effecting the purchasing of the new item or picking up of the item, there is the great possibility that the user buys other goods at that store on his way, thereby enhancing business results of the store. In consideration of such enhancement, since there is the great possibility that the stores approve of the above-mentioned system, the network system can easily be expanded.

Incidentally, in the illustrated embodiment, while an example that the user effects the request by using the user's computer 13 at home was explained, a computer corresponding to the user's computer 13 may be set at the store as a terminal from which the user can effect the request. In this case, when the request is effected through the terminal equipment, as mentioned above, since there is the great possibility that the user buys other goods at the store, it is favorable for the store and the company has a merit that the purchasing of the new item is promoted and, thus, the recycling is more promoted. Thus, the pick-up charge may be discounted when the request is effected via the terminal equipment.

Further, by using the network system, not only the picking up of the item but also the purchasing of the new item and picking up of the old item can be promoted. Since the sale of new items is promoted by the purchasing of the new item and picking up of the old item, the company has greater merit. Thus, when the user requests for purchasing the new item and picking up the old item, the company may give a special favor to the user when the user requests for purchasing the new item and picking up the old item. Such a special favor may be, for example, free (charge) service of printer ink or printing papers or a perchandise coupon which can be used at the store. Such a special favor can be applied to both the case where the request is effected through the terminal equipment and the case where the purchasing of the new item and picking up of the old item is requested. Further, such a special favor may be given to the user after the completion of the purchasing of the new item and picking up of the old item or the picking up of the item is ascertained through the database 51 (FIG. 5).

Further, in the user request view shown in FIG. 4, by obtaining an opinionaire regarding the items such as item use years and the like from the users, such opinions can be referred to development of new items and new users can be acquired. Further, the pick-up item may be forwarded from the store directly to the recycling company, rather than from the store to the recycling collection center.

The above-mentioned illustrated embodiment is merely an example of the present invention, and, thus, it should be noted that the present invention is not limited to the illustrated embodiment. Therefore, various alterations and modifications can be made without departing from the scope of the present invention.

As mentioned above, according to the present invention, the purchasing of the new item and picking up of the old item or the picking up of the item can be effected at the designated place. Since the request for purchasing the new item and picking up the old item or picking up the item is effected through the network, the user can perform the request easily, thereby promoting the recycling and utilizing the resources effectively.

What is claimed is:

1. A network apparatus comprising:
request designating means for designating request for purchasing a new item or picking up an item to be recycled;
place designating means for designating a place where said purchasing or picking-up is performed; and
communication means for notifying the request information designated by said request designating means and the place designated by said place designating means to an external place through a network.

2. A network apparatus according to claim 1, further comprising address inputting means for inputting an address of a requester, and wherein said place designating means displays one or plural proposed places in the vicinity of the address of the requester among which said place can be designated by the requester.

3. A network apparatus according to claim 1, further comprising E-mail address inputting means for inputting an E-mail address of a requester, and wherein said communication means notifies the E-mail address of the requester to the external place and receives information regarding a date of said purchasing or picking-up on the basis of the E-mail address of the requester.

4. A network apparatus according to claim 1, wherein said communication means receives identification information required for said purchasing or picking-up on the basis of the E-mail address of the requester.

5. A network apparatus according to claim 1, further comprising picked-up item information inputting means for inputting information regarding the item to be picked up when purchasing or picking-up, and wherein said communication means further notifies the picked-up item information to the external place.

6. A network apparatus according to claim 1, further comprising newly purchased item information inputting means for inputting information regarding the item to be newly purchased when the request for purchasing the new item is designated by said request designating means, and wherein said communication means further notifies the newly purchased item information to the external place.

7. A network apparatus comprising:
input means for inputting request information regarding request for purchasing of a new item or picking up an item and place information regarding a place where said purchasing or picking-up is performed through a network; and
output means for outputting a purchasing date or a pick-up date through said network to inform a requester of the purchasing date or the pick-up date.

8. A network apparatus according to claim 7, further comprising completion information acquiring means for acquiring information regarding completion of said pick-up through said network.

9. A network apparatus comprising:
input means for inputting request information regarding request for purchasing of a new item or picking up an item to be recycled and place information regarding a place where said purchasing or picking-up is performed through a network;
output means for outputting a purchasing date or a pick-up date through said network to inform a requester of the purchasing date or the pick-up date; and
completion information acquiring means for acquiring information regarding completion of said pick-up through said network.

10. A network system in which a first network apparatus and a second network apparatus are interconnected through a network, wherein:
said first network apparatus comprises request designating means for designating request for purchasing a new item or picking up an item to be recycled; place designating means for designating a place where the purchasing or picking-up is performed; and
communication means for notifying the request information designated by said request designating means and the place designated by said place designating means to said second network apparatus through said network; and
said second network apparatus comprises input means for inputting request information regarding the request for purchasing of a new item or picking up an item to be recycled and place information regarding the place where said purchasing or picking-up is performed from said first network apparatus through said network; and output means for outputting a purchasing date or a pick-up date to said first network apparatus through said network to inform a requester of the purchasing date or the pick-up date.

11. A network system according to claim 10, wherein said second network apparatus further comprises completion information acquiring means for acquiring information regarding completion of said pick-up through said network.

12. A network system in which a first network apparatus and a second network apparatus are interconnected through a network, wherein:
said first network apparatus comprises input means for inputting request information regarding request for purchasing of a new item or picking up an item to be recycled and place information regarding a place where said purchasing or picking-up is performed through said network; output means for outputting a purchasing date or a pick-up date through said network to inform a requester of the purchasing date or the pick-up date; and completion information acquiring means for acquiring information regarding completion of said pick-up from said second network apparatus through said network; and
said second network apparatus comprises notifying means for informing said first network apparatus of the information regarding the completion of said pick-up after said completion.

13. A network system in which a first, a second and a third network apparatuses are interconnected through a network, wherein:
said first network apparatus comprises request designating means for designating request for purchasing a new item or picking up a pick-up item to be recycled; place designating means for designating a place where said purchasing or picking-up is performed; and communication means for notifying the request information designated by said request designating means and the place designated by said place designating means to said second network apparatus through said network;
said second network apparatus comprises input means for inputting request information regarding the request for purchasing a new item or picking up an item and place information regarding a place where said purchasing or picking-up is performed from said first network apparatus through said network; output means for outputting a purchasing date of a pick-up date to said first network apparatus through said network to inform a requester of the purchasing date or the pick-up date; and completion information acquiring means for acquiring information regarding completion of said pick-up from said third network apparatus through said network; and
said third network apparatus comprises notifying means for informing said second network apparatus of the information regarding the completion of said pick-up after said completion.

14. A communication method comprising the steps of:
(a) designating request for purchasing a new item or picking up an item to be recycled;
(b) designating a place where said purchasing or picking-up is performed; and
(c) notifying the designated request and the designated place to an external place through a network.

15. A communication method comprising the steps of:
(a) inputting request information regarding request for purchasing of a new item or picking up an item to be recycled and place information regarding a place where said purchasing or picking-up is performed through a network; and
(b) outputting a purchasing date or a pick-up date through said network to inform a requester of the purchasing date or the pick-up date.

16. A communication method according to claim 15, further comprising a step of (c) acquiring information regarding completion of said pick-up through said network.

17. A computer-readable recording medium for storing a program having a sequence which is executed by a computer, wherein said sequence comprises the steps of:
(a) designating request for purchasing a new item or picking up an item to be recycled;
(b) designating a place where said purchasing or picking-up is performed; and
(c) notifying the designated request and the designated place to an external place through a network.

18. A computer-readable recording medium for storing a program having a sequence which is executed by a computer, wherein said sequence comprises the steps of:
(a) inputting request information regarding request for purchasing of a new item or picking up an item to be recycled and place information regarding a place where said purchasing or picking-up is performed through a network; and
(b) outputting a purchasing date or a pick-up date through said network to inform a requester of the purchasing date or the pick-up date.

19. A recording medium according to claim 18, wherein said sequence further comprises a step of (c) acquiring information regarding completion of said pick-up through said network.
